(19) United States
(12) Patent Application Publication
(10) Pub. No.: US 2012/0140629 A1
(43) Pub. Date: Jun. 7, 2012

(54) ROUTING METHOD

(75) Inventors: Young Ae JEON, Daejeon (KR); Sangjae Lee, Daejeon (KR); Sangsung Choi, Daejeon (KR)

(73) Assignee: ELECTRONICS AND TELECOMMUNICATIONS RESEARCH INSTITUTE, Daejeon (KR)

(21) Appl. No.: 13/307,146

(22) Filed: Nov. 30, 2011

(30) Foreign Application Priority Data
Dec. 2, 2010 (KR) 10-2010-0122234

(51) Int. Cl. H04W 40/02; H04W 72/04; H04W 28/10

(52) U.S. Cl. 370/235; 370/328; 370/329

(57) ABSTRACT

A routing method from a source device to a destination device is provided in a device within an extended beacon group. The device receives a first route request beacon from the source device or via at least one first neighbor device from the source device in accordance with a table-driven type. The device transmits a second route request beacon to the destination device or via at least one second neighbor device to the destination device in accordance with an on-demand type.

### CROSS-REFERENCE TO RELATED APPLICATION

This application claims priority to and the benefit of Korean Patent Application No. 10-2010-0122234 filed in the Korean Intellectual Property Office on Dec. 2, 2010, the entire contents of which are incorporated herein by reference.

### BACKGROUND

(a) Field

The present invention relates to a routing method, and more particularly, to a routing method for distributed medium access control (DMAC) based multi-hop communication.

(b) Description of the Related Art

A high-speed wireless communication technology based on the DMAC is a technology that supports various types of services by wirelessly connecting audio/video devices, computers, peripherals, etc., which are located at a short distance from each other and in a single beacon group, and by supporting communication between small-sized multimedia devices that are conveniently portable and are operated by low power. The high-speed wireless communication technology is being standardized in the WiMedia Alliance.

Generally, in high-speed wireless communication networks, connections (i.e., communications) among two or more devices are initiated by the transmission/reception of beacons among devices that belong to a beacon group (BG) and share the same beacon period start time (BPST). However, in an extended beacon group (EBG), which is the union of the beacon groups of all devices within a certain beacon group, the routes of all the devices cannot be established using only single-hop communication.

That is, devices that share the same beacon period start time and belong to the single beacon group can communicate with one another in a single-hop manner, but devices that belong to different beacon groups cannot establish their routes in the single-hop manner. Therefore, a new type of communication technology that allows two devices, which are present in the extended beacon group and belong to different beacon groups, to establish their routes and communicate with each other is required.

### SUMMARY OF THE INVENTION

Embodiments of the present invention provide a routing method for enabling efficient communication between devices within an extended beacon group.

According to an embodiment of the present invention, a routing method from a source device to a destination device in a device within an extended beacon group is provided. The method includes receiving a first route request beacon from the source device or via at least one first neighbor device from the source device in accordance with a table-driven type, and transmitting a second route request beacon to the destination device or via at least one second neighbor device to the destination device in accordance with an on-demand type.

The device may reserve medium access slots for data transmission of an interval from the source device or the first neighbor device to the device while receiving the first route request beacon.

The device may broadcast the second route request beacon when transmitting the second route request beacon.

The first and second route request beacons each may include an information element. The information element may include identification information of the source device, identification information of the destination device, a minimum bandwidth requested by the source device, and a bandwidth desired by the source device.

The information element may further include a number of hops from the source device to the destination device and a number of medium access slots from the source device to the destination device.

The method may further include receiving a first route response beacon from the destination device or via the second neighbor device from the destination device in accordance with the on-demand type, and transmitting a second route response beacon to the source device or via the first neighbor device to the source device in accordance with the table-driven type.

The device may reserve medium access slots for data transmission of an interval from the destination device or the second neighbor device to the device while receiving the first route response beacon.

A method according to another embodiment of the present invention includes receiving a first route request beacon from a source device or via at least one first neighbor device from the source device, determining whether at least one second neighbor device that satisfies a quality of service (QoS) required by the source device exists, and transmitting a second route request beacon to a second neighbor device when the second neighbor device that satisfies the QoS exists. In this case, the second neighbor device is the destination device or a third device between the device and the destination device.

The method may further include receiving a first route response beacon from the second neighbor device, and transmitting a second route response beacon to the source device or to the first neighbor device.

The device may reserve medium access slots for data transmission when transmitting the second route response beacon.

The device may broadcast the second route request beacon when transmitting the second route request beacon.

A method according to yet another embodiment of the present invention includes acquiring link state topology information of a plurality of devices within the extended beacon group, receiving a first route request beacon from the source device or via at least one neighbor device from the source device, determining whether a QoS route to the destination device exists based on the topology information, and transmitting a second route request beacon to the destination device or to a next-hop device on the QoS route when the QoS route exists.

The method may further include receiving a first route response beacon from the destination device or from the next-hop device, and transmitting a second route response beacon to the source device or to the neighbor device.

The device may reserve medium access slots for data transmission when transmitting the second route request beacon.

When acquiring the link state topology information, the device may generate a first link state information element in accordance with a link state between the device and a first neighbor device, receive a second link state information element from a second neighbor device, and broadcast a beacon including the first and second link state information elements.

The first link state information element may include an identifier of a neighbor device that forms a link with a device that generates the first link state information element, a data transmission rate of the link, and a number of medium access slots used in the link.

### BRIEF DESCRIPTION OF THE DRAWINGS

FIG. 1 is a drawing showing a structure of a MAC superframe of a DMAC-based high speed wireless communication network according to an embodiment of the present invention.

FIG. 2 is a drawing showing a single beacon group of a DMAC-based high speed wireless communication network according to an embodiment of the present invention.

FIG. 3 is a drawing showing an extended beacon group of a DMAC-based high speed wireless communication network according to an embodiment of the present invention.

FIG. 4 is a diagram showing an example of a multi-hop information element for DMAC-based multi-hop communication according to an embodiment of the present invention.

FIG. 5 is a drawing showing an example of an MDRP control field shown in FIG. 4.

FIG. 6 is a diagram showing an example of a multi-hop information element for DMAC-based multi-hop communication according to an embodiment of the present invention.

FIG. 7 is a drawing showing an example of a link information field shown in FIG. 6.

FIG. 8 is a drawing showing an on-demand type routing procedure for multi-hop communication according to an embodiment of the present invention.

FIG. 9 is a flowchart showing an on-demand type routing method according to an embodiment of the present invention.

FIG. 10 is a drawing showing a table-driven type of routing procedure for multi-hop communication according to an embodiment of the present invention.

FIG. 11 is a flowchart showing a table-driven type of routing method according to an embodiment of the present invention.

FIG. 12 is a drawing showing a hybrid type of routing procedure for multi-hop communication according to an embodiment of the present invention.

FIG. 13 is a flowchart showing a hybrid type of routing method according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

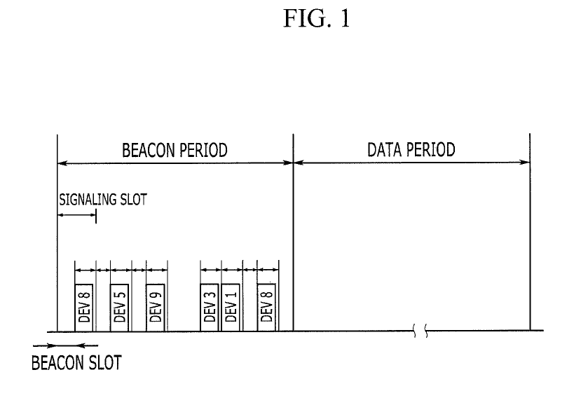

FIG. 1 is a drawing showing a structure of a medium access control (MAC) superframe of a DMAC-based high speed wireless communication network according to an embodiment of the present invention.

The superframe includes a plurality of medium access slots (MASs), and a MAS corresponds to a time slot. For example, the superframe may have a length of 65,536 μs and includes 256 MASs each having a length of 256 μs.

Referring to FIG. 1, the superframe starts with a beacon period (BP), and a beginning time of the first MAS of the beacon period is called a beacon period start time (BPST). The MASs of the beacon period are called beacon slots, and sequence numbers starting from 0 are sequentially allocated to the beacon slots. Each of the beacon slots is allocated to a corresponding one of devices DEV 1, DEV 5, DEV 8, and DEV 9. Some first beacon slots, for example the first two beacon slots, are called signaling slots. The MASs except the beacon periods in the superframe correspond to a data period, and the data period includes a prioritized contention access (PCA) period for transmitting data and a distributed reservation protocol (DRP) period.

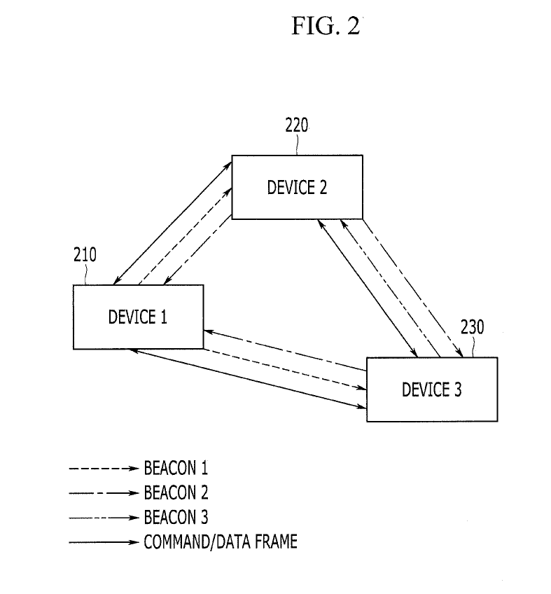

FIG. 2 is a drawing showing a single beacon group of a DMAC-based high speed wireless communication network according to an embodiment of the present invention.

Referring to FIG. 2, each of devices 210, 220, and 230 transmits its beacon and receives a beacon from the other devices in its beacon slot. The devices 210, 220, and 230 transmit or receive a command/data frame. A beacon frame includes network management information such that synchronization of devices, power management, and allocation of data periods may be performed. MAC protocols of all devices may function the same such that they can distributively operate without a central control device.

For example, the device 210 searches the surroundings for beacons, and then determines whether a beacon group that is operating around the device 210 exists, based on the searching results. If no beacon group exists, the device 210 transmits a beacon frame that is generated based on a device identifier (DEVID), a device slot number, and device control information, thus forming a new beacon group. The device control information may include a beacon period length, a beacon slot information bitmap, and a device address corresponding to the beacon slot information bitmap. In this case, other devices 220 and 230 individually search for this beacon frame, and generate and transmit their own beacon frames on the basis of information on the beacon frame. The devices (for example, the devices 210 and 220 or the devices 210 and 230) transmit and receive the beacon frames therebetween, thus communicating with each other in a single-hop manner. If the beacon group exists around the device 210, the device 210 can become a member of the beacon group by transmitting its beacon to the beacon group.

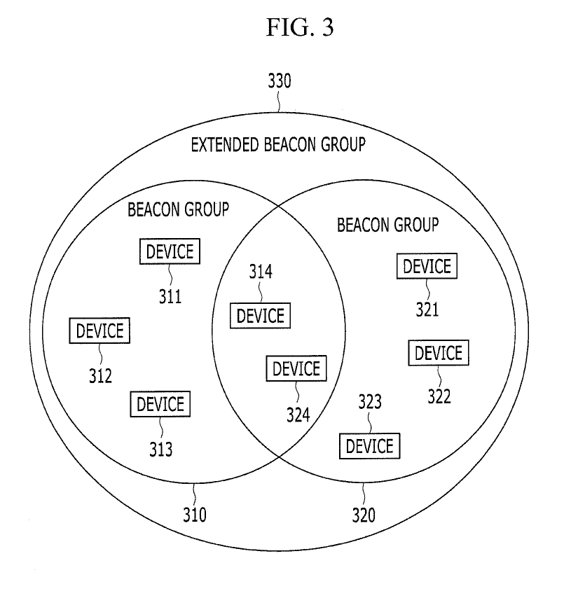

FIG. 3 is a drawing showing an extended beacon group of a DMAC-based high speed wireless communication network according to an embodiment of the present invention.

Referring to FIG. 3, devices using the same BPST form a single beacon group. That is, devices 311, 312, 313, 314, and 324 form one beacon group 310 since they use the same BPST, and devices 314, 321, 322, 323, and 324 form the other beacon group 320 since they use the same BPST. An extended beacon group is formed by a set of the beacon groups of the devices that belong to the beacon groups 310 and 320. That is, because the devices 314 and 324 belong to the beacon group 310 and also belong to the beacon group 320, the two beacon groups 310 and 320 are extended by the two devices 314 and 324 and form the extended beacon group 330.

Accordingly, the device 311 within the beacon group 310 can perform multi-hop communication with the external device 321 within the beacon group 320 by the device 314 that also belongs to the beacon group 320. As a result, multi-hop communication can be performed between two devices of the different beacon groups.

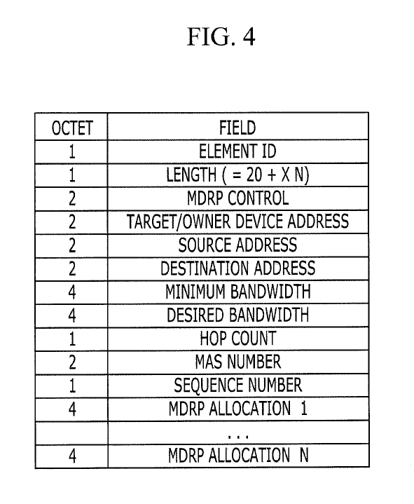

Next, a multi-hop information element for multi-hop communication according to an embodiment of the present invention will be described with reference to FIG. 4 to FIG. 7.

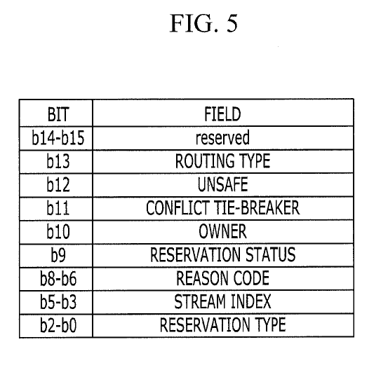

FIG. 4 is a diagram showing an example of a multi-hop information element for DMAC-based multi-hop communication according to an embodiment of the present invention, and FIG. 5 is a drawing showing an example of an MDRP control field shown in FIG. 4.

Referring to FIG. 4, a multi-hop DRP information element (MDRP IE) of the multi-hop information includes an element ID field, a length field, an MDRP control field, a target/owner device address field, a source address field, a destination address field, a minimum bandwidth field, a desired bandwidth field, a hop count field, a MAS number field, a sequence number field, and a plurality of MDRP allocation fields.

The MDRP IE enables a routing function to be performed in a MAC layer not a network layer, and enables the single-hop communication to be extended to the multi-hop communication.

The element ID field indicates the ID of the MDRP IE, and may have one byte (i.e., an octet).

The length field indicates the byte-based length of the information element, except for the element ID field and the length field, and may have one byte.

The target/owner device address field indicates identification information of a destination device transmitting the MDRP IE, and may have two bytes. The target/owner device address field may be set as “Oxffff” that is a value for indicating no specific address in the case of broadcasting.

The source address field indicates identification information of an initial source device that requests a route, and may have two bytes.

The destination address field indicates identification information of the final destination device of the route, and may have two bytes.

The minimum bandwidth field indicates the minimum bandwidth required to transmit data requested by a MAC client of the source device, and may have four bytes. The unit of the bandwidth may be in Kbps.

The desired bandwidth field indicates the bandwidth desired to be allocated to transmit data requested by the MAC client of the source device, and may have four bytes. The unit of the bandwidth may be in Kbps.

The hop count field indicates the number of hops from the source device to the destination device, and increases by 1 whenever it passes through an intermediate device. The hop count field may have one byte.

The MAS number field indicates the number of MASs from the source device to the destination device, and increases by the number of required MASs whenever it passes through an intermediate device. The MAS number field may have two bytes.

The sequence number field indicates the sequence number of the MDRP IE, and is used to classify a message. The sequence number field may have one byte.

Each MDRP allocation field includes zone bitmap information and MAS bitmap information, and each of the zone bitmap information and the MAS bitmap information may have two bytes. Here, a zone includes 16 MASs and a single superframe may include 16 zones.

Referring to FIG. 5, the MDRP control field includes a routing type field, an unsafe field, a conflict tie-breaker field, an owner field, a reservation status field, a reason code field, a stream index field, and a reservation type field. The MDRP control field may have two bytes. The routing type field, the unsafe field, the conflict tie-breaker field, the owner field, the reservation status field, the reason code field, the stream index field, and the reservation type field may have 1 bit (b13), 1 bit (b12), 1 bit (b11), 1 bit (b10), 1 bit (b9), 3 bits (b6 to b8), 3 bits (b3 to b5), and 3 bits (b0 to b2), respectively. The remaining 2 bits (b14, b15) may be reserved fields.

The routing type field indicates a routing type desired to be used. The routing type field may be set to ‘0’ when the routing type is a table-driven type, and may be set to ‘1’ when the routing type is an on-demand type.

The unsafe field indicates whether a MAS identified in the MDRP allocation field exceeds a threshold for resource allocation.

The conflict tie-breaker field is randomly set to ‘0’ or ‘1’ when resources are allocated, and have the same value with respect to the same MDRP IE.

The owner field indicates whether a device using the corresponding MDRP IE transmits or receives data. The owner field may be set to ‘1’ when the device transmits data, and may be set to ‘0’ when the device receives data.

The reservation status field is set to ‘1’ when resource allocation is completed.

The reason code field indicates the following meanings depending on the set values.

‘0’: “Accepted” indicating that a request for MDRP reservation has been completed.

‘1’: “Conflict” indicating that a conflict exists in the request for MDRP reservation.

‘2’: “Pending” indicating that the request for MDRP reservation is pending.

‘3’: “Denied” indicating that the request for MDRP reservation has been denied.

‘4’: “Modified” indicating that the request for DRP reservation has been modified.

‘5’: “Route error” indicating that an error has occurred in a link.

The stream index field indicates the ID of a stream that is transmitted using the corresponding MDRP IE.

The reservation type field indicates the following meanings depending on the set values.

‘0’: “Alien BP” indicating the beacon period of the other beacon group.

‘1’: “Hard” indicating that only a source device can use resources.

‘2’: “Soft” indicating that the source device primarily uses resources, but other devices can competitively use resources when the source device does not use the resources.

‘3’: “Private” indicating that a resource allocation method defined by a vendor is applied.

‘4’: “PCA” indicating that resources can be used in a carrier sense multiple access/collision avoidance (CSMA/CA) manner.

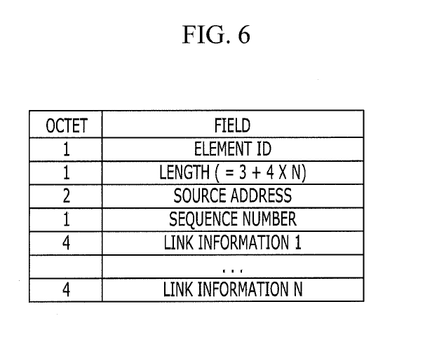

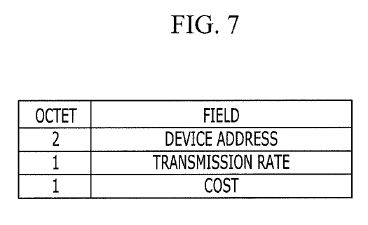

FIG. 6 is a diagram showing an example of a multi-hop information element for DMAC-based multi-hop communication according to an embodiment of the present invention, and FIG. 7 is a drawing showing an example of a link information field shown in FIG. 6.

Referring to FIG. 6, a link state information element (LS IE) of a multi-hop information element includes an element ID field, a length field, a source address field, a sequence number field, and a plurality of link information fields.

The element ID field indicates an ID of the LS IE.

The length field indicates the byte-based length of the information element, except for the element ID field and the length field.

The source address field indicates identification information of an initial source device that requests a route.

The sequence number field indicates the sequence number of the LS IE, and is used to classify a message.

Referring to FIG. 7, the link information field includes a device address field, a transmission rate field, and a cost field, which may have 2 bytes, 1 byte, and 1 byte, respectively.

The device address field indicates an ID of a neighbor device that forms a link with a device that initially generates and transmits the LS IE.

The transmission rate field indicates the data transmission rate of the link formed between the two devices.

The cost field indicates a number of MASs that are used in the link formed between the two devices.

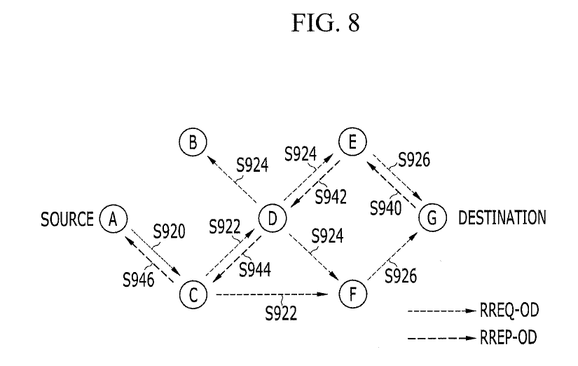

Next, a routing method for a multi-hop communication using a multi-hop information element will be described with reference to FIG. 8 to FIG. 13.

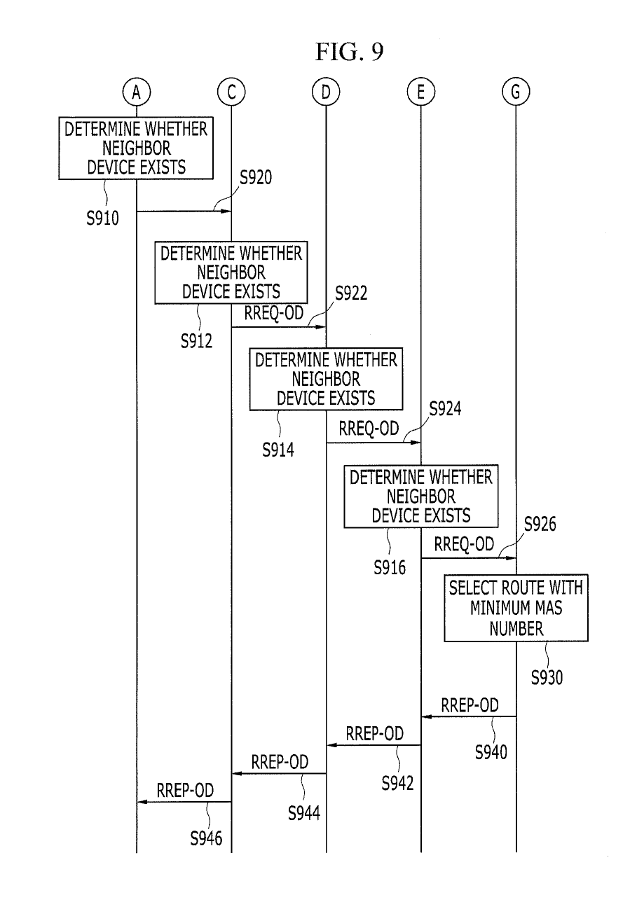

FIG. 8 is a drawing showing an on-demand type of routing procedure for a multi-hop communication according to an embodiment of the present invention, and FIG. 9 is a flowchart showing an on-demand type of routing method according to an embodiment of the present invention. FIG. 8 and FIG. 9 show an on-demand type of routing procedure from a device A which is an initial source device to a device G which is a final destination device.

Referring to FIG. 8 and FIG. 9, the device A determines whether a neighbor device that can satisfy a quality of service (QoS) required by the device A exists, in order to establish a multi-hop route to an outside device G that does not belong to its beacon group (S910). If at least one neighbor device that can provide the QoS exists, the device A broadcasts a beacon including an on-demand type of route request (RREQ-OD) MDRP IE (S920).

If the neighbor devices B and C, which have received the RREQ-OD MDRP IE, are not the destination device, they determine whether a neighbor device provides the QoS (S912) and broadcast the RREQ-OD MDRP IE (S922). However, the device B discards the received RREQ-OD MDRP IE and does not participate in the routing procedure because it does not have a neighbor device for providing the QoS or receives a duplicated RREQ-OD MDRP IE.

This procedure is repeated so that the RREQ-OD MDRP IEs arrive at the destination device G via the different routes (S914, S924, S916, and S926). The destination device G can wait for a predetermined time after receiving the first RREP-OD MDRP IE in order to receive two or more RREP-OD MDRP IEs. When receiving RREP-OD MDRP IEs via two or more routes, the device G selects a route with the minimum number of MASs (S930), and transmits a beacon including an on-demand type of route response (RREP-OD) MDRP IE to a neighbor device E corresponding to backward of the selected route (S940).

The RREP-OD MDRP IE is transmitted to the source device A via the backward route (G→E→d→C→A) (S942, S944, and S946). MASs required for data transmission are reserved during this procedure. The reserved MASs may be automatically released if they are not used for a predetermined time so that performance deterioration according to a reservation error of unnecessary MASs can be prevented. The device A, which has received the RREP-OD MDRP IE, completes the routing establishment to the device G, and starts to transmit data to the device G.

In FIG. 8 and FIG. 9, an owner field of RREQ-OD MDRP-IE and an owner field of the RREP-OD MDRP-IE are set to ‘1’ and ‘0’, respectively, and their routing type fields are set to ‘1’.

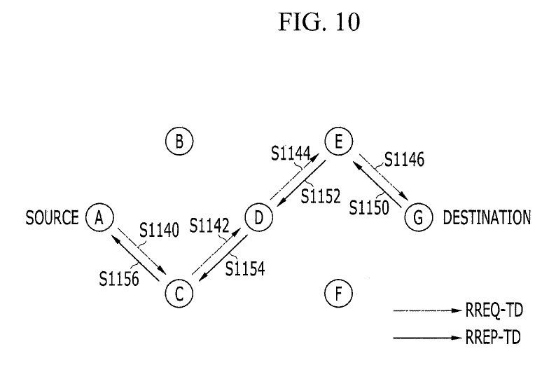

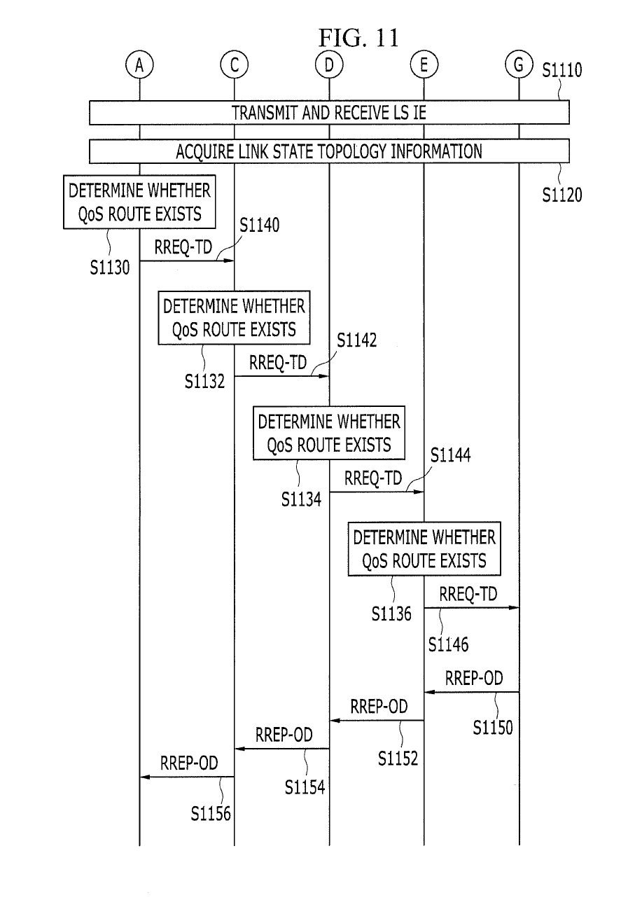

FIG. 10 is a drawing showing a table-driven type of routing procedure for a multi-hop communication according to an embodiment of the present invention, and FIG. 11 is a flowchart showing a table-driven type of routing method according to an embodiment of the present invention. FIG. 10 and FIG. 11 show a table-driven type of routing procedure from a device A which is an initial source device to a device G which is a final destination device.

Before establishing a route, each device within an extended beacon group analyzes a link state between itself and each neighbor device, generates an LS IE for each neighbor device, and adds the LS IE to a beacon to be periodically broadcasted (S1110). The LS IE may include a transmission rate between the devices and the number of MASs that are currently used on the link. The neighbor device, which has received the LS IE, adds the received LS IE as well as its LS IE to a beacon that it will broadcast. Since the LS IEs are broadcasted, each device acquires link state topology information for all devices within the extended beacon group, and analyzes QoS routes to other devices in advance, using a minimum cost algorithm such as Dijkstra algorithm or Bellman-Ford algorithm based on the information (S1120).

When establishing the route, the initial source device A determines whether the QoS route to the destination device G exists, based on the topology information analyzed in advance (S1130). When the QoS route to the destination device G exists, the device A transmits a beacon including a table-driven type of route request (RREQ-TD) MDRP IE to a next-hop device C on the QoS route (S1140).

If the device C, which has received the RREQ-TD MDRP IE, is not the destination device, it determines whether the QoS route to the destination device G exists, based on its topology information (S1132). When the QoS route to the destination device G exists, the device C transmits a beacon including the RREQ-TD MDRP IE to a next-hop device D on the QoS route (S1142). If the QoS route does not exist, the device C discards the RREQ-TD MDRP IE.

The unicast transmission is repeated so that the RREQ-TD MDRP IE arrives at the destination device G via a forward route (A→C→D→E→G) (S1134, S1144, S1136, and S1146). Differently from the on-demand type, MASs required for data transmission are reserved while the RREQ-TD MDRP IE is transmitted, in the table-driven type. The reserved MASs may be automatically released if they are not used for a predetermined time so that performance deterioration according to a reservation error of unnecessary MASs can be prevented.

After receiving the RREQ-TD MDRP IE, the device G transmits a beacon including a table-driven route response (RREP-TD) MDRP IE to a neighbor device E corresponding to backward of the route. The RREP-TD MDRP IE is transmitted to the source device A via the backward route (G→E→D→C→A) (S1150, S1152, S1154, and S1156). The device A, which has received the RREP-TD MDRP IE, completes the routing establishment to the device G, and starts to transmit data to the device G.

In FIG. 8 and FIG. 9, an owner field of RREQ-TD MDRP-IE and an owner field of the RREP-TD MDRP-IE are set to ‘1’ and ‘0’, respectively, and their routing type fields are set to ‘0’.

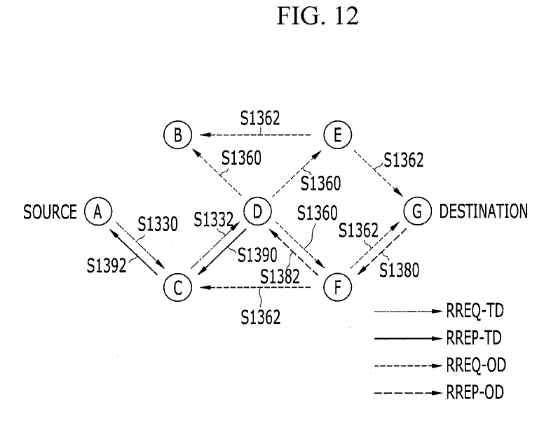

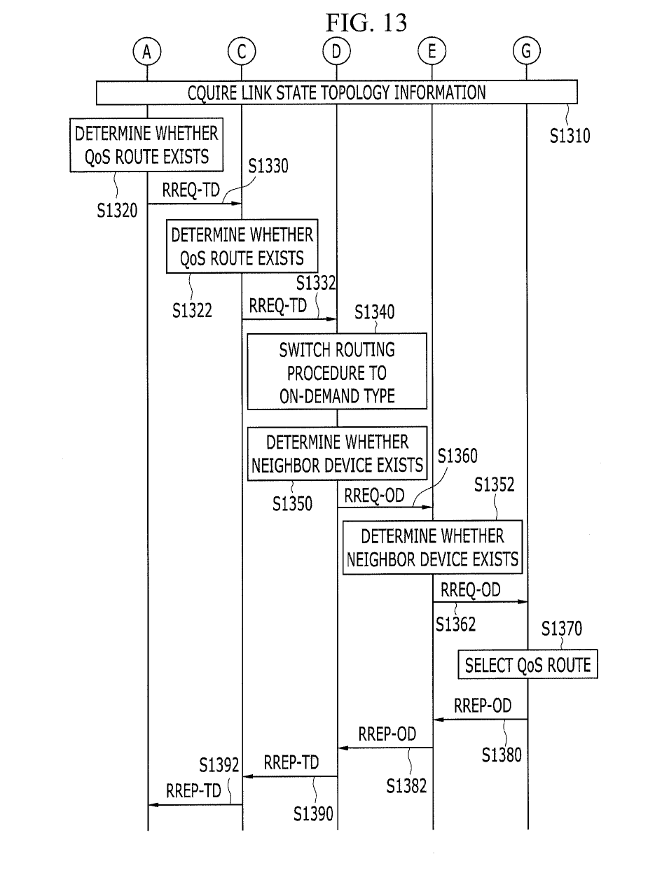

FIG. 12 is a drawing showing a hybrid type of routing procedure for a multi-hop communication according to an embodiment of the present invention, and FIG. 13 is a flowchart showing a hybrid type of routing method according to an embodiment of the present invention. FIG. 12 and FIG. 13 show a hybrid type of routing procedure from a device A which is an initial source device to a device G which is a final destination device.

The hybrid type selectively uses a table-driven type and an on-demand type, thereby using merits of each type and compensating defects of each type. Therefore, each device within an extended beacon group analyzes a link state topology for the extended beacon group in advance by transmitting and receiving an LS IE according to the table-driven type, independently from the routing procedure (S1310).

When establishing the route, the initial source device A determines whether a QoS route to the destination device G exists, based on the topology information analyzed in advance (S1320). When the QoS route to the destination device G exists, the device A transmits a table-driven type of route request (RREQ-TD) MDRP IE to a next-hop device C on the QoS route, thereby initiating a table-driven type of routing procedure (S1330).

The RREQ-TD MDRP IE arrives at a device D via a device C (S1322 and S1332). While the RREQ-TD MDRP IE is transmitted from the source device A to the device D, the device D may lose the QoS route to the destination device G by a change of the topology. In this case, the device D switches the routing procedure from the table-driven type to the on-demand type (S1340).

The device D determines whether a neighbor device that can satisfy the QoS required by the route to the destination G exists (S1350), and then broadcasts a beacon including the RREP-OD MDRP IE (S1360).

The broadcasting is repeated so that the RREQ-OD MDRP IEs arrive at the destination device G (S1352 and S1362). The device G selects the QoS route based on the received RREQ-OD MDRP IEs (S1370), and transmits the RREP-OD MDRP IE to a neighbor device F corresponding to backward of the selected route (S1380).

The RREP-OD MDRP IE is transmitted to the device D that initiates the on-demand type of routing procedure via the backward route (G→F→D) (S1382). The device, which has received RREP-OD MDRP IE, switches RREP-OD MDRP IE to the RREP-TD MDRP IE and transmits the RREP-TD MDRP IE the neighbor device G on the backward route (S1390).

The RREP-TD MDRP IE is transmitted to the source device via the backward route (D→C→A) (S1392). The device A, which has received the RREP-TD MDRP IE, completes the routing establishment to the device G, and starts to transmit data to the device G. MASs for data transmission are reserved while the RREQ-TD MDRP IE is transmitted according to the table-driven type in an interval from the device A to the device D, and are reserved while the RREP-OD MDRP IE is transmitted according to the on-demand type in an interval from the device D to the device G.

As described above, according to an embodiment of the present invention, multi-hop communication between devices within an extended beacon group as well as a single-hop communication between devices within a single beacon group can be performed, and an information element for the communications can be provided.

Further, according to an embodiment of the present invention, a QoS is considered in the routing procedure so that the routing can be efficiently performed.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A routing method from a source device to a destination device in a device within an extended beacon group, the method comprising:
receiving a first route request beacon from the source device or via at least one first neighbor device from the source device in accordance with a table-driven type; and
transmitting a second route request beacon to the destination device or via at least one second neighbor device to the destination device in accordance with an on-demand type.

2. The method of claim 1, further comprising reserving medium access slots for data transmission of an interval from the source device or the first neighbor device to the device while receiving the first route request beacon.

3. The method of claim 1, wherein transmitting the second route request beacon comprises broadcasting the second route request beacon.

4. The method of claim 1, wherein the first and second route request beacons each comprise an information element,
wherein the information element comprises identification information of the source device, identification information of the destination device, a minimum bandwidth requested by the source device, and a bandwidth desired by the source device.

5. The method of claim 4, wherein the information element further comprises a number of hops from the source device to the destination device and a number of medium access slots from the source device to the destination device.

6. The method of claim 1, wherein further comprising:
receiving a first route response beacon from the destination device or via the second neighbor device from the destination device in accordance with the on-demand type; and
transmitting a second route response beacon to the source device or via the first neighbor device to the source device in accordance with the table-driven type.

7. The method of claim 6, further comprising reserving medium access slots for data transmission of an interval from the destination device or the second neighbor device to the device while receiving the first route response beacon.

8. A routing method from a source device to a destination device in a device within an extended beacon group, the method comprising:
receiving a first route request beacon from the source device or via at least one first neighbor device from the source device;
determining whether at least one second neighbor device that satisfies a quality of service (QoS) required by the source device exists; and
transmitting a second route request beacon to a second neighbor device when the second neighbor device that satisfies the QoS exists,
wherein the second neighbor device is the destination device or a third device between the device and the destination device.

9. The method of claim 8, further comprising:
receiving a first route response beacon from the second neighbor device; and
transmitting a second route response beacon to the source device or to the first neighbor device.

10. The method of claim 9, wherein transmitting the second route response beacon comprises reserving medium access slots for data transmission.

11. The method of claim 8, wherein transmitting the second route request beacon comprises broadcasting the second route request beacon.

12. The method of claim 8, wherein the first and second route request beacons each comprise an information element,
wherein the information element comprises identification information of the source device, identification information of the destination device, a minimum bandwidth requested by the source device, and a bandwidth desired by the source device.

13. The method of claim 12, wherein the information element further comprises a number of hops from the source device to the destination device and a number of medium access slots from the source device to the destination device.

14. A routing method from a source device to a destination device in a device within an extended beacon group, the method comprising:
acquiring link state topology information of a plurality of devices within the extended beacon group;
receiving a first route request beacon from the source device or via at least one neighbor device from the source device;
determining whether a QoS route to the destination device exists, based on the topology information; and
transmitting a second route request beacon to the destination device or to a next-hop device on the QoS route when the QoS route exists.

15. The method of claim 14, further comprising:
receiving a first route response beacon from the destination device or from the next-hop device; and
transmitting a second route response beacon to the source device or to the neighbor device.

16. The method of claim 14, wherein transmitting the second route request beacon comprises reserving medium access slots for data transmission.

17. The method of claim 14, wherein the first and second route request beacons each comprise an information element,
wherein the information element comprises identification information of the source device, identification information of the destination device, a minimum bandwidth requested by the source device, and a bandwidth desired by the source device.

18. The method of claim 17, wherein the information element further comprises a number of hops from the source device to the destination device and a number of medium access slots from the source device to the destination device.

19. The method of claim 14, wherein acquiring the link state topology information comprises:
generating a first link state information element in accordance with a link state between the device and a first neighbor device;
receiving a second link state information element from a second neighbor device; and
broadcasting a beacon including the first and second link state information elements.

20. The method of claim 19, wherein the first link state information element comprises:
an identifier of a neighbor device that forms a link with a device that generates the first link state information element;
a data transmission rate of the link; and
a number of medium access slots used in the link.
